(19) United States
(12) Patent Application Publication
(10) Pub. No.: US 2022/0311764 A1
(43) Pub. Date: Sep. 29, 2022

(54) DEVICE FOR AND METHOD OF AUTOMATICALLY DISABLING ACCESS TO A MEETING VIA COMPUTER

(71) Applicant: Daniel Oke, Bowie, MD (US)

(72) Inventor: Daniel Oke, Bowie, MD (US)

(21) Appl. No.: 17/703,956

(22) Filed: Mar. 24, 2022

Related U.S. Application Data
(60) Provisional application No. 63/165,571, filed on Mar. 24, 2021.

(51) Int. Cl. H04L 9/40; H04L 65/4038

(52) U.S. Cl. CPC H04L 63/0861; H04L 65/4038

(57) ABSTRACT

Exemplary arrangements comprise a computer including a processor readable medium embodying processor executable instruction. Responsive to execution of the instructions by at least one processor of the computer, the exemplary processor is operative to: display a video conferencing program on an exemplary display screen in operative connection with the computer; enable a user to select and request access to a meeting arranged on the video conferencing program through an input to at least one input device in operative connection with the computer; make a determination whether the user of the computer is compliant with at least one meeting access condition; responsive to a determination that the user is not compliant with the at least one meeting access condition, deny the user access to the meeting; and responsive to a determination that the user is compliant with the at least one meeting access condition, permit the user access to the meeting.

### FIELD OF INVENTION

The exemplary arrangements relate to a device for and a method of automatically enabling and disabling audio/video access to a meeting via a computer.

### BACKGROUND

People are conducting more meetings via computers. One reason for this is the COVID-19 virus, which discourages face-to-face meetings.

While participating in a meeting via a computer, a user may physically leave a room in which the computer is located without electronically exiting the meeting. In this situation, the other meeting participants may continue to provide audio, provide chat information, and share content with the computer. Therefore, the information provided may be revealed to a person unknown to the other participants in the meeting or when the person chooses not to participate in the meeting. Thus, there is a need to automatically disable access to a meeting via a computer when a user physically leaves the meeting or disables his/her microphone without properly exiting the meeting electronically, without requiring the user to provide an additional input to the computer.

### SUMMARY

Exemplary arrangements comprise a computer including a processor readable medium embodying processor executable instructions. Responsive to execution of the instructions by at least one processor of the computer, the exemplary processor is operative to: display a video conferencing program on an exemplary display screen in operative connection with the computer; enable a user to select and request access to a meeting arranged on the video conferencing program through an input to at least one input device in operative connection with the computer; make a determination whether the user of the computer is compliant with at least one meeting access condition; responsive to a determination that the user is not compliant with the at least one meeting access condition, deny the user access to the meeting; and responsive to a determination that the user is compliant with the at least one meeting access condition, permit the user access to the meeting.

In exemplary arrangements, after access to the meeting has been permitted, the processor is operative to continually monitor the user for compliance with the at least one meeting access condition.

In exemplary arrangements, after access to the meeting has been permitted, the processor is operative to revoke the user's access to the meeting responsive to a determination that the user is no longer compliant with the at least one meeting access condition.

In exemplary arrangements, after access to a meeting has been denied or revoked, the processor is operative to: continually monitor the user for compliance with the at least one meeting access condition; and responsive to a determination that the user is compliant with the at least one meeting access condition, permit the user access to the meeting.

In exemplary arrangements, the at least one meeting access condition includes a determination by the processor that the user has enabled a camera in operative connection with the computer.

In exemplary arrangements, the camera includes a field of view and the at least one meeting access condition further includes a determination by the processor that the user is detected within the field of view of the camera.

In exemplary arrangements, the camera is configured to detect at least one of a facial or retinal feature of the user of the computer, and the at least one meeting access condition incudes a determination by the processor that the detected facial or retinal feature of the user matches data corresponding to facial or retinal features stored in a memory in operative connection with the computer.

In exemplary arrangements, revocation of meeting access by the processor includes revocation of access to content shared by other compliant users in the meeting.

In exemplary arrangements, the content includes at least one of: a meeting chat function; meeting audio output; and meeting video output.

In exemplary arrangements, responsive to the processor executable instructions, the processor is further operative to record and store in the memory data corresponding to events of the meeting.

In exemplary arrangements, the data corresponding to events of the meeting includes data corresponding to at least one of: a number of non-compliant meeting users; a time corresponding to when a user becomes compliant; a time corresponding to when a user becomes non-compliant; a percentage of a total time of a meeting in which the user is compliant; a non-compliant activity of a user including at least one of a camera that is not enabled or the user is not detected within the field of view of the camera; and a compliant activity including at least one of a camera that is enabled and the user is detected within the field of view of the camera.

Alternative exemplary arrangements comprise a processor implemented method, including the steps of: displaying a video conferencing program on a display screen in operative connection with a computer; enabling a user to select and request access to a meeting arranged on the video conferencing program through an input to at least one input device in operative connection with the computer; determining whether the user of the computer is compliant with at least one meeting access condition; responsive to a determination that the user is not compliant with the at least one meeting access condition, denying the user access to the meeting; responsive to a determination that the user is compliant with the at least one meeting access condition, permitting the user access to the meeting; after access to the meeting has been permitted, monitoring the user continuously for compliance with the at least one meeting access condition; after access to the meeting has been permitted, revoking the user's access to the meeting responsive to a determination that the user is no longer compliant with the at least one meeting condition. In such exemplary methods, the at least one meeting access condition includes at least one of: determining that the user has enabled a camera in operative connection with the computer; determining that the user is detected within a field of view of a camera in operative connection with the computer; and the camera being configured to detect at least one of a facial or retinal feature of the user of the computer, and determining that the detected facial or retinal feature of the user matches data corresponding to facial or retinal features stored in a memory in operative connection with the computer.

Alternative exemplary arrangements comprise a computer including a processor readable medium embodying processor executable instructions. Responsive to execution of the instructions by at least one processor of the computer, the processor is operative to: display a video conferencing program on a display screen in operative connection with the computer; enable a user to access a meeting arranged on the video conferencing program responsive to a processor determination that the user of the computer is compliant with at least one meeting access condition; and deny a user access to the meeting responsive to a processor determination that the user is not compliant with the at least one meeting access condition.

### DESCRIPTION OF FIGURES

FIG. 1 is a schematic of an exemplary computer of an exemplary arrangement;

FIG. 2 is an illustration of a user in front of the exemplary computer of FIG. 1;

FIG. 3 is an illustration of an image of the user illustrated in FIG. 1 on an exemplary display of an exemplary computer of another user who participates in a meeting with the user illustrated in FIG. 1;

FIG. 4 is an illustration of the exemplary computer illustrated in FIG. 1, where the user illustrated in FIG. 1 is not in front of the computer;

FIG. 5 is an illustration of the exemplary computer of the other user illustrated in FIG. 3, where the user illustrated in FIG. 1 is not in front of the computer illustrated in FIG. 1 and, thus, the user is not visible on the exemplary display of the computer of the other user; and

FIG. 6 is a flowchart of an exemplary method of an exemplary arrangement.

### DESCRIPTION OF INVENTION

The exemplary arrangements provide a device for and a method of automatically enabling and disabling access to a meeting via a computer. Further, the exemplary arrangements provide a device for and method of improving the user interface of a computer. More particularly, the exemplary arrangements provide a computer including a processor readable medium embodying processor executable instruction that, when executed by a processor of the computer, improve the user interface or other functions of the computer. However, the exemplary arrangements are not limited thereto.

In exemplary arrangements, the ability of a user's computer to receive information provided by others participating in a meeting via computers (e.g., audio, chat information, shared content, etc.) is automatically disabled when the user either turns off a camera connected to the computer of the user or the user is not within a range or field of view of the camera. Thus, if the user is participating in a meeting via the user's computer, the ability of the user's computer to receive audio, chat information, and other content (e.g. shared content) from the other participants in the meeting is automatically disabled when a camera in operative connection with the user's computer is not turned on or the user is no longer identified as being within the visual range or field of view of the camera. By doing so, information from the meeting is not provided to the user's computer or audio or visual devices in operative connection therewith when the camera on the user's computer is not turned on or the user physically leaves the meeting (i.e., the field of view of the camera) without properly exiting the meeting electronically.

In exemplary arrangements, the exemplary computer includes a display screen in operative connection therewith. The exemplary display screen is operative to display a video conferencing program. For purposes herein, the term video conferencing program includes any virtual meeting or teleconferencing software, application, or web-based platform. For example, the term video conferencing program includes, but is not limited to, Microsoft Teams®, Google Meet®, Zoom Meetings®, Webex®, or any other available teleconferencing software, applications, or web-based platforms. Of course, this arrangement is merely exemplary, and in other embodiments, other arrangements may be used.

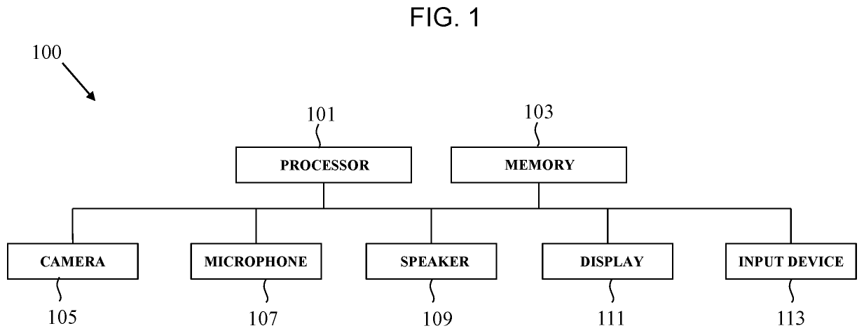

FIG. 1. is a schematic of a computer 100 of an exemplary arrangement.

Referring to FIG. 1, the exemplary computer 100 includes a processor 101, a memory 103, a camera 105 (e.g., a webcam), a microphone 107, a speaker 109, a display screen 111, and an input device 113. In exemplary arrangements, the processor 101, the memory 103, the camera 105, the microphone 107, the speaker 109, the display screen 111, and the input device 113 are connected via a bidirectional bus 115, also referred to herein as a circuit 115. The exemplary camera 105 is positioned on the display 111 of the computer 100 to face forward and capture an image of a user when the user is within a visual range or field of view of the camera 105 (e.g., in front of the display 111 of the computer 100).

The exemplary camera 105, in conjunction with the exemplary processor 101, identifies a user as being within a visual range of the camera 105 by either detection of the user within a field of view of the camera at 105, facial recognition, retinal recognition, or any other suitable method of identifying the user. In such exemplary arrangements, the camera 105 is configured to detect and capture an image of at least one of a facial feature or retinal feature of the user of the computer. The processor 101 is operative to cause the camera 105 to capture an image of the facial or retinal feature and to cause the image (or data corresponding thereto) to be stored in the memory 103 of the computer 100. Thereafter, when a user later attempts to gain access to a meeting, the processor 101 is operative to cause the camera 105 to detect and/or capture a new image of the facial or retinal feature of the user and to compare the newly captured image to the stored image or data, and to make a determination that the newly captured image matches the stored image or data, thereby permitting the user access to the meeting. Of course, this arrangement is merely exemplary, and in other embodiments, other arrangements may be used.

In alternative exemplary arrangements, the exemplary computer 100 may include at least one sensor. The exemplary at least one sensor is configured to sense when the user is within a certain range of the computer 100. The exemplary sensor may be a motion sensor, a light sensor, a sound sensor, or any other type of sensor. In such arrangements, when the exemplary sensor detects the user within range of the computer 100, the processor 101 is operative to permit the user access to the meeting.

In alternative exemplary arrangements, the exemplary camera 105 may not be positioned on the display 111 of the computer 100. Rather, the camera 105 may be in operatively wired or wireless connection with the computer 100. In exemplary arrangements in which the camera 105 is in wireless connection with the computer 100, the computer 100 and the camera 105 are configured to wirelessly communicate via a telecommunications network. As can be appreciated, these alternative arrangements are merely exemplary, and in other embodiments, other arrangements may be used.

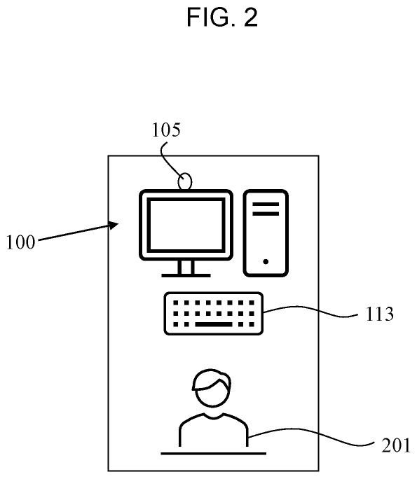

FIG. 2 is an illustration of a user 201 in front of the computer 100.

Referring to FIG. 2, the user 201 may use the exemplary input device 113 (e.g., a computer mouse, voice input, user movement based input such as sign language, or any other suitable computer input device) to turn off the camera 105 so that an image of the user is not output from the computer 100 (e.g., an image of the user is not captured, or transmitted to any other computer, by the computer 100). Similarly, the user 201 may use the exemplary input device 113 to turn on the camera 105 so that the image of the user is output from the computer 100. Of course, this arrangement is merely exemplary, and in other embodiments, other arrangements may be used.

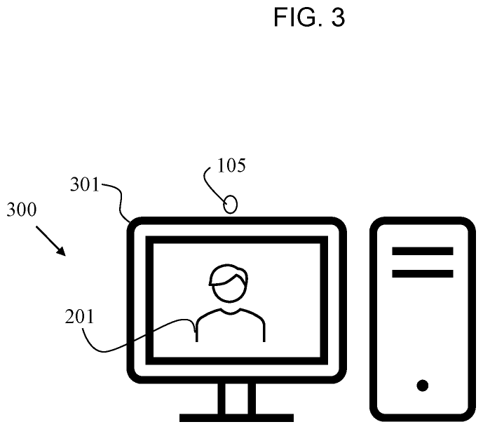

FIG. 3 is an illustration of an image of the user 201 illustrated in FIG. 1 on a computer 300 of another user (not shown) who is in a meeting with the user 201 illustrated in FIG. 1 via the computer 100 of the user 201 and the computer 300 of the other user.

Referring to FIG. 3, the image of the user 201 appears on a display 301 of the computer 300 of the other user when the user 201 is within the visual range of the camera 105 or sensor of the computer 100 of the user 201.

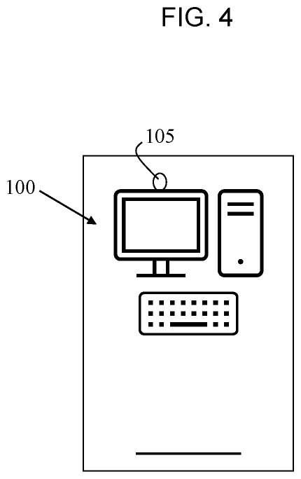

FIG. 4 is an illustration of the computer 100 illustrated in FIG. 1, where the user 201 illustrated in FIG. 1 is not in front of the computer 100 and is not within the visual range of the camera 105 of the computer 100.

Referring to FIG. 4, the user 201 is not in front of the computer 100 of the user 201 and, thus, is not within the visual range of the camera 105 of the computer 100.

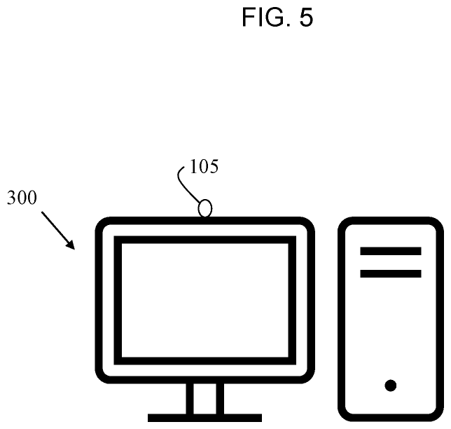

FIG. 5 is an illustration of the computer 300 of the other user illustrated in FIG. 3, where the user 201 illustrated in FIG. 1 is not in front of the computer 100 illustrated in FIG. 1 and is not within the visual range of the cameral 105 and, thus, is not visible on the display 301 of the computer 300 of the other user.

Referring to FIG. 5, the computer 300 of the other user does not display an image of the user 201, because the user 201 is not within the visual range of the camera 105 of the computer 100 of FIG. 4 and, thus, no image of the user is transmitted to, or displayed on, the computer 300 of the other user.

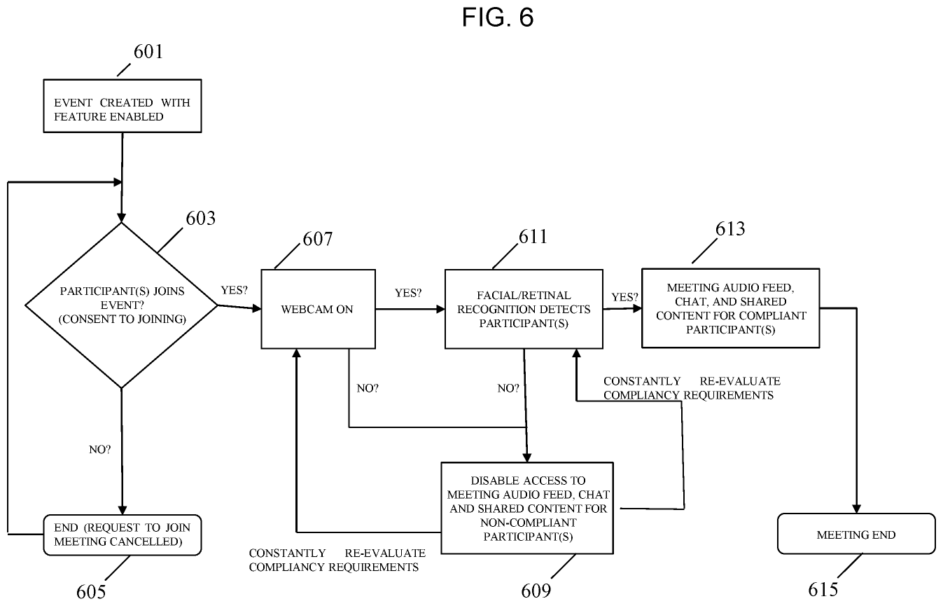

FIG. 6 is a flowchart of an exemplary method.

In exemplary arrangements, the memory 103 includes processor readable instructions executable by the processor 101. The exemplary processor executable instructions include operations including a video web conferencing program or feature that utilizes facial/retinal recognition, after a webcam or camera of a computer is enabled, that initially allows potential participants to a meeting via computers access to audio of the meeting, a chat function or platform of the meeting, and access to content shared by other participants who have been given access to the meeting by complying with meeting access conditions, such as being within range of a field of view of a camera of the computer. As can be appreciated, these arrangements are merely exemplary, and in other embodiments, other arrangement may be used.

In exemplary arrangements, if a participant disables their webcam and/or facial/retinal recognition does not detect the participant within its field of view (e.g., the participant becomes a non-compliant participant) then access to the audio of the meeting, the meeting chat, and access to content shared by other compliant participants is revoked from the non-compliant participant. In exemplary arrangements, the meeting access conditions that include one or both of the webcam being enabled and the participant being detected within the field of view the webcam or camera/sensor are continuously re-evaluated in order to re-instate access to the audio of the meeting, the meeting chat, and access to content shared by other compliant participants. The conditions must be met by a participant in order to remain compliant for the extent of the meeting. Of course, these processor executable instructions and operations are merely exemplary, and in other embodiments, other or additional processor executable instructions and operations may be used.

Referring to FIG. 6, an exemplary method of automatically disabling access to a meeting via a computer includes a first step 601 of creating an event with a feature enabled. In an exemplary arrangement, the event is a meeting via computers and the feature enabled is a camera (e.g., a webcam). However, as can be appreciated, these method steps are merely exemplary, and in other embodiments, other method steps may be used.

The second step 603 of the exemplary method is determining if a participant or user joins the event. In an exemplary arrangement, a participant joins the event when a user of a computer requests to join the event and an authority grants consent for the user to join, and participate in, the event (e.g., the user becomes a participant).

If it is determined in the second step 603 of the exemplary method that the user was not granted consent to join the event, then the third step 605 of the method is cancelling the user's request to join the meeting and returning to the second step 603 to continuously monitor whether a user of a computer requests to join the event.

If it is determined in the second step 603 of the method that the user was granted consent to join the event (e.g., the user is now a participant in the event), then the fourth step 607 of the method is determining if the user's/participant's webcam on the user's computer is turned on.

If it is determined in the fourth step 607 of the exemplary method that the user's webcam on the user's computer is not turned on, then the fifth step 609 of the method is disabling access of the user's/participant's computer to event audio (e.g., meeting audio), event chat information (e.g., meeting chat information), and content shared by other participants who are compliant (e.g., participants who were granted access to the event and have their webcams on their computers turned on) and returning to the fourth step 607 to continuously monitor whether the webcam on the user's/participant's computer is turned on. As can be appreciated, this arrangement is merely exemplary, and in other embodiments, other method steps may be used.

If it is determined in the fourth step 607 of the exemplary method that the user's webcam on the user's computer is turned on, then the sixth step 611 of the method is determining if the user/participant is recognized using the webcam of the user's computer. In an exemplary arrangement, a user is recognized using the webcam of the user's computer by using facial recognition or retinal recognition. However, this arrangement is merely exemplary, and in other embodiments, other arrangements may be used.

If it is determined in the sixth step 611 of the method that the user/participant is not recognized using the webcam of the user's computer, then the method proceeds to the fifth step 609 of the method to disable access of the user's/participant's computer to event audio (e.g., meeting audio), event chat information (e.g., meeting chat information), and content shared by other participants who are compliant (e.g., participants who were granted access to the event and have their webcams on their computers turned on) and return to the sixth step 611 to continuously monitor whether the user/participant is recognized using the webcam of the user's computer.

If it is determined in the sixth step 611 of the method that the user/participant is recognized using the webcam of the user's computer then the seventh step 613 of the method is enabling access of the user's/participant's computer to event audio (e.g., meeting audio), event chat information (e.g., meeting information), and content shared by other participants who received consent to join the event and have their webcams turned on.

The eighth step 615 of the method is terminating (e.g., ending) the event (e.g., meeting) when the event reaches its conclusion.

In alternative exemplary arrangements, the exemplary processor 103 may execute further instructions stored on the memory 103 including operations for tracking and/or recording meeting metrics during an event and storing such meeting metrics on the memory 103. These metrics may include various aspects of the meeting including, but not limited, to a number of non-compliant participants during an event, and details about the occurrences by the non-compliant participants. The details may include the type of activity that resulted in the user being classified as non-compliant, the participants associated with each occurrence, when the act occurred during the event and the duration of each non-compliant occurrence.

In alternative exemplary arrangements, the meeting access condition may include periodically requiring the user to cause an input to the computer through the at least one input device. If the user does not cause the input to the computer through the input device at periodic intervals of time, the processor is operative to revoke the user's access to the meeting. This alternative meeting access condition may be a standalone meeting access condition or can be combined with the other meeting access conditions of enabling a camera in operative connection with the computer, detecting the user within a field of view of the camera, or detecting and matching and or confirming a facial or retinal feature of the user via the camera. Of course, these meeting access conditions are merely exemplary, and in other embodiments, other meeting access conditions may be required of the user.

As can be appreciated, the exemplary arrangements and methods discussed herein may be implemented in or on any type of computing device. For example, without limitation, the exemplary arrangements and methods may be implemented in or on desktop computers, laptops computers, electronic smart pads, smart phones, or any other type of computing device.

Although a few exemplary arrangements and methods have been illustrated and described, it will be appreciated by those skilled in the art that changes may be made in these exemplary arrangements and methods, and combinations of the various features and relationships and methods steps of the exemplary arrangements and methods may be made without departing from the principles and spirit of the disclosure, the scope of which is defined in the appended claims and their equivalents.

What is claimed is:

1. A computer including a processor readable medium embodying processor executable instructions,
wherein responsive to execution of the instructions by at least one processor of the computer, the processor is operative to
display a video conferencing program on a display screen in operative connection with the computer,
enable a user to select and request access to a meeting arranged on the video conferencing program through an input to at least one input device in operative connection with the computer,
make a determination whether the user of the computer is compliant with at least one meeting access condition,
responsive to a determination that the user is not compliant with the at least one meeting access condition, deny the user access to the meeting, and
responsive to a determination that the user is compliant with the at least one meeting access condition, permit the user access to the meeting.

2. The computer according to claim 1,
wherein after access to the meeting has been permitted, the processor is operative to continually monitor the user for compliance with the at least one meeting access condition.

3. The computer according to claim 2,
wherein after access to the meeting has been permitted, the processor is operative to revoke the user's access to the meeting responsive to a determination that the user is no longer compliant with the at least one meeting access condition.

4. The computer according to claim 3,
wherein after access to a meeting has been denied or revoked, the processor is operative to
continually monitor the user for compliance with the at least one meeting access condition, and
responsive to a determination that the user is compliant with the at least one meeting access condition, permit the user access to the meeting,

5. The computer according to claim 4, further comprising:
wherein the at least one meeting access condition includes a determination by the processor that the user has enabled a camera in operative connection with the computer.

6. The computer according to claim 5,
wherein the camera includes a field of view,
wherein the at least one meeting access condition further includes a determination by the processor that the user is detected within the field of view of the camera.

7. The computer according to claim 6,
wherein the camera is configured to detect at least one of a facial or retinal feature of the user of the computer,
wherein the at least one meeting access condition incudes a determination by the processor that the detected facial or retinal feature of the user matches data corresponding to facial or retinal features stored in a memory in operative connection with the computer.

8. The computer according to claim 7,
wherein revocation of meeting access by the processor includes revocation of access to content shared by other compliant users in the meeting.

9. The computer according to claim 8,
wherein the content includes at least one of
a meeting chat function,
meeting audio output, and
meeting video output.

10. The computer according to claim 9,
wherein responsive to the processor executable instructions, the processor is further operative to record and store in the memory data corresponding to events of the meeting.

11. The computer according claim 10,
wherein the data corresponding to events of the meeting includes data corresponding to at least one of
a number of non-compliant meeting users,
a time corresponding to when a user becomes compliant,
a time corresponding to when a user becomes non-compliant,
a percentage of a total time of a meeting in which the user is compliant, a non-compliant activity of a user including at least one of a camera that is not enabled or the user is not detected within the field of view of the camera, and
a compliant activity including at least one of a camera that is enabled and the user is detected within the field of view of the camera.

12. The computer according to claim 1,
wherein the at least one meeting access condition includes a determination by the processor that the user has enabled a camera in operative connection with the computer.

13. The computer according to claim 1, further comprising:
a camera in operative connection with the computer, wherein the camera includes a field of view,
wherein the at least one meeting access condition includes a determination by the processor that the user is detected within the field of view of the camera.

14. The computer according to claim 1, further comprising:
a camera, wherein the camera is configured to detect at least one of a facial or retinal feature of the user of the computer,
wherein the at least one meeting access condition includes a determination by the processor that the detected facial or retinal feature of the user matches data corresponding to facial or retinal features stored in a memory in operative connection with the processor.

15. A processor implemented method, comprising:
a) displaying a video conferencing program on a display screen in operative connection with a computer;
b) enabling a user to select and request access to a meeting arranged on the video conferencing program through an input to at least one input device in operative connection with the computer;
c) determining whether the user of the computer is compliant with at least one meeting access condition;
d) responsive to a determination that the user is not compliant with the at least one meeting access condition, denying the user access to the meeting; and
e) responsive to a determination that the user is compliant with the at least one meeting access condition, permitting the user access to the meeting.

16. The processor implemented method of claim 15, further comprising:
g) after access to the meeting has been permitted, monitoring the user continuously for compliance with the at least one meeting access condition.

17. The processor implemented method of claim 16, further comprising:
h) after access to the meeting has been permitted, revoking the user's access to the meeting responsive to a determination that the user is no longer compliant with the at least one meeting condition.

18. The processor implemented method of claim 15,
wherein the at least one meeting access condition includes determining that the user has enabled a camera in operative connection with the computer.

19. The processor implemented method of claim 15,
wherein the at least one meeting access condition includes determining that the user is detected within a field of view of a camera in operative connection with the computer.

20. The processor implemented method of claim 15,
wherein the computer includes a camera in operative connection therewith, wherein the camera is configured to detect at least one of a facial or retinal feature of the user of the computer,
wherein the at least one meeting access condition includes determining that the detected facial or retinal feature of the user matches data corresponding to facial or retinal features stored in a memory in operative connection with the computer.

21. A computer including a processor readable medium embodying processor executable instructions,
wherein responsive to execution of the instructions by at least one processor of the computer, the processor is operative to
display a video conferencing program on a display screen in operative connection with the computer,
enable a user to access a meeting arranged on the video conferencing program responsive to a processor determination that the user of the computer is compliant with at least one meeting access condition, and
deny a user access to the meeting responsive to a processor determination that the user is not compliant with the at least one meeting access condition.
